(19) United States
(12) Patent Application Publication
(10) Pub. No.: US 2015/0376905 A1
(43) Pub. Date: Dec. 31, 2015

(54) Ceiling Tile Cutter

(71) Applicant: Winfield Scott Brown, II, Hagerstown, MD (US)

(72) Inventor: Winfield Scott Brown, II, Hagerstown, MD (US)

(21) Appl. No.: 14/752,926

(22) Filed: Jun. 27, 2015

Related U.S. Application Data
(60) Provisional application No. 62/018,524, filed on Jun. 27, 2014.

(51) Int. Cl. E04F 21/00; B26B 29/06

(52) U.S. Cl. CPC E04F 21/0076; B26B 29/06

(57) ABSTRACT

A ceiling tile cutter constructed from a two piece metal edge, with a recess machined so that a standard drop ceiling, ceiling tile can engage the cutting tool and be secure in a locked position. The cutting tool is a straight bar comprising the recess and two slits where a standard retractable blade knife or any knife using standard knife blades can be inserted. Running a knife blade along/through the two slits results in a notched removal of the tile material from the end of the tile engaged with the cutter resulting in a notch allowing a cut ceiling tile to be placed and retained by the ceiling runners in a flat and smooth manner consistent with a preformed tile.

### CROSS REFERENCE TO RELATED APPLICATIONS:

This application claims priority from U.S. patent application Ser. No. 62/018,524, entitled “A Ceiling Tile Cutter”, filed on Jun. 27, 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a cutting tool for creating a recessed edge on a ceiling tile. More specifically, the present invention relates to a cutting tool for creating a recessed edge on a ceiling tile that can be used to accurately finish the edge of a ceiling tile to be placed in a grid in a dropped ceiling.

### BACKGROUND OF THE INVENTION

Ceiling tiles are sold in pre-set shapes and are mounted in a grid that is hung suspended from a ceiling. The ceiling tiles are slightly larger than the openings in the grid and have a recess surrounding the entire edge. The recessed edge of the ceiling tiles rest on top of the grid when the opening shape and the size of the ceiling tile are as designed. The center portion of the tile can then extend below the level of the grid and create a finished appearance.

In any instances, the size and shape of a room does not allow the use of standard sized ceiling tiles and the ceiling tiles must be cut into a smaller or irregular shape in order to complete a room ceiling. This results in the elimination of portions of the recessed edges and prevents smooth mounting of the ceiling tile into the grid since the portion of the ceiling tile missing the recessed edge cannot sit flat in the grid.

In order to create a recessed edge along the cut tile, a perfectly straight cut must be made in two directions, perpendicular to each other. As a result of the two perpendicular cuts, a portion of the ceiling tile is removed and a matching recess to that of the ceiling tile is created so that the entire edge of the modified ceiling tile now has a recessed edge allowing the middle potion to fit within the grid while being retained in placed by the recessed portion.

### SUMMARY OF THE INVENTION

A ceiling tile cutter constructed from a two piece metal edge, with a recess machined so that a standard drop ceiling, ceiling tile can engage the cutting tool and be secure in a locked position. The cutting tool is a straight bar comprising the recess and two slits where a standard retractable blade knife or any knife using standard knife blades can be inserted. Running a knife blade along/through the two slits results in a notched removal of the tile material from the end of the tile engaged with the cutter resulting in a notch allowing a cut ceiling tile to be placed and retained by the ceiling runners in a flat and smooth manner consistent with a preformed tile.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIGS. 1-2 are perspective views of the top and bottom of the device of the present invention;

FIGS. 3-4 are perspective views of the top and bottom of the device of the present invention illustrating how the device would fit over a standard ceiling tile; and

FIG. 5 is a side perspective view of the device of the present invention in a multi-piece construction embodiment.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

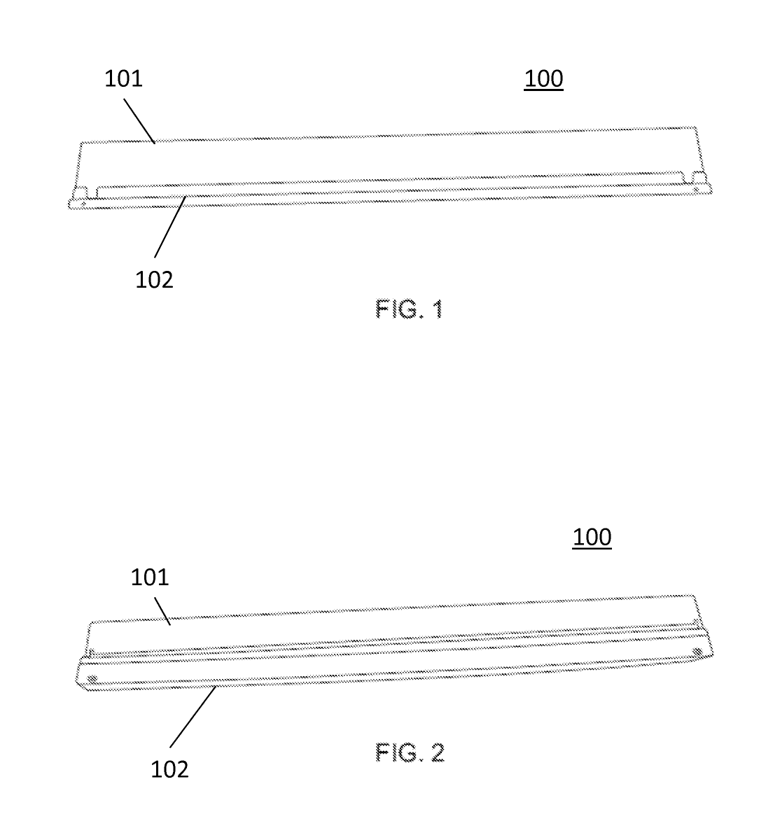

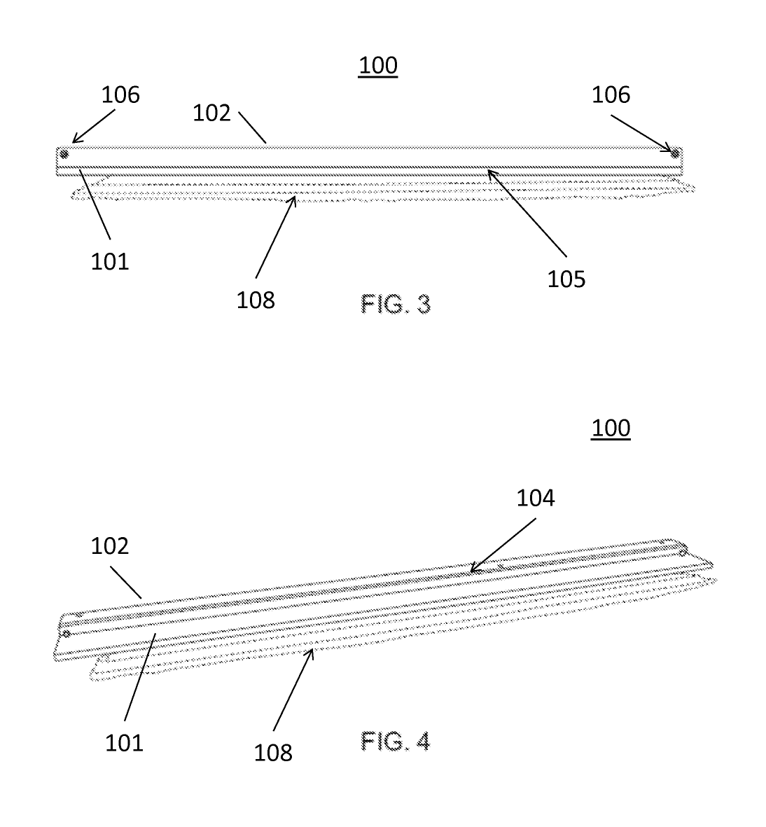

Now referring to Figures, the embodiments of the cleaning device are shown. A ceiling tile cutter 100 is constructed from a two piece 101 and 102 metal edge as shown in FIGS. 1-2, with a recess 103 machined so that a standard drop ceiling, ceiling tile can engage the cutting tool and be secured in a locked position as shown in FIGS. 3-4.

The cutting tool 100 is a straight bar comprising a recess 103 and two perpendicular slits 104 and 105 where a standard retractable blade knife or any knife using standard knife blades can be inserted. Running a knife blade along/through the two slits 104 and 105 results in a notched removal of the tile material from the end of the tile 108 engaged with the cutter 100 resulting in a corresponding notch or recess in the cut tile allowing the cut ceiling tile to be placed and retained by the ceiling runners/grid in a flat and smooth manner consistent with a preformed tile.

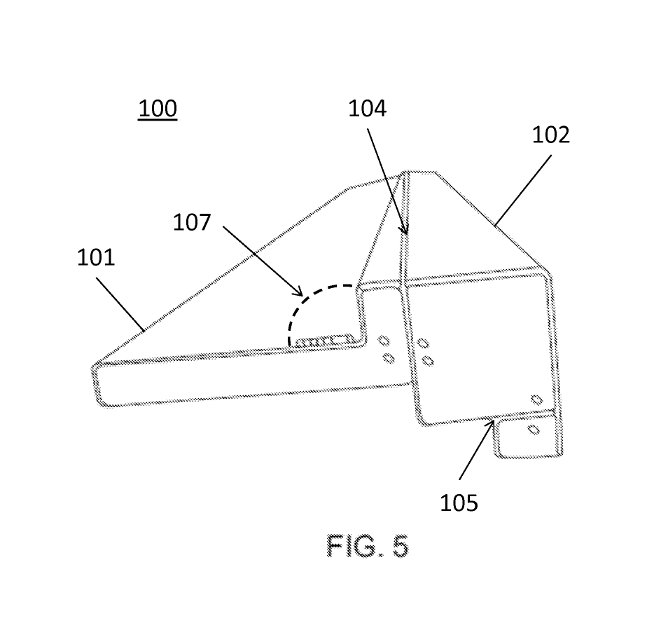

In the present embodiment shown in FIGS. 1-4, the ceiling tile cutting device 100 is constructed from two aluminum components 101 and 102 as shown in FIG. 5. The multi-piece version of the device is held together by machine screws 105 and is made from the more durable metal material such as aluminum for use by a contractor or in a commercial setting. The device can be made from any material readily known to those of ordinary skill in the art such as any grade of steel or aluminum.

In an alternative embodiment, to cut production cost, the device will be made of plastic. The inventor has had twenty prototypes made using acrylic plastic that was machined to cut cost until being able to afford injection molding. These pieces were machined just like the originals made from aluminum, except they were made from hard acrylic plastic since I could cut cost buying it in a sheet. If there is a good demand the Inventor will be able to spend the money to make them using injection molding, which would be a better price point for a consumer model compared to a contractor grade model made from aluminum.

As illustrated in the Figures, a first metal edge 101, acting as a straight bar; has a recess 107 machined into it so that a standard drop ceiling, ceiling tile 108 can be secured in a locked position. A second metal edge 102 is attached to the end of the first metal edge 101 containing the machined recess 107. The first and second edge pieces 101 and 102 are connected to each other. A second slot/slit 105 is machined into the second metal edge 102 where a standard retractable blade knife or any knife using standard knife blades can be inserted for making a cut in a tile 108. The first slit 104 and second slit 105 are perpendicular to each other. Running a knife blade along/through the two perpendicular slits 104 and 105 results in a notched removal of the tile material from the end of the tile 108 engaged with the tile cutting device 100.

In another embodiment, the device can be made in one piece from injection molded plastic or a combination of metal and injection molded plastic. For cost and manufacturing purposes, it may be necessary to product an embodiment from cheaper materials for the do it yourself (DYI) or home repair segment, where the device must be produced at a lower cost point to make it feasible and attractive for home owners to purchase for small projects, yet provide a device that is rigid and strong enough to be used for small scale projects, unlike commercial projects or as part of a contractors tools of the trade, which would need to be made from materials that can withstand repeated use.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A ceiling tile cutting device comprising:
a first edge acting as a straight bar;
a recess machined into the first edge so that a standard drop ceiling, ceiling tile can secure in a locked position;
a second edge attached to the end of the first metal edge containing the machined recess;
a second slit machined into the second edge;
where the first and second edge pieces connected to each other a gap between the first and second edge pieces creates a first slit;
the first slit and second slit are perpendicular to each other; and
a standard retractable blade knife or any knife using standard knife blades can be inserted for making a cut in a tile.

2. The device of claim 1, wherein running a knife blade along/through the two perpendicular slits results in a notched removal of the tile material from the end of the tile engaged with the device.

3. The device of claim 1 wherein the first and second edges are made from aluminum.

4. The device of claim 1, wherein the first and second edges are made from acrylic plastic that was machined to cut cost until being able to afford injection molding.

5. The device of claim 1, wherein the first and second edges are made from injected molded plastic.

6. A ceiling tile cutting device comprising:
a rectangular body made of injected molded plastic;
the rectangular body having a raised box lip along the length of one long end;
a recess machined into the raised end so that a standard drop ceiling, ceiling tile can secure in a locked position;
a first slot running the length of the recess on the rectangular body end with the raised box lip;
a second slot running the length of the recess on the raised box lip; and
the first slot and second slot are perpendicular to each other.

7. The device of claim 6, wherein running a knife blade along/through the two perpendicular slots results in a notched removal of the tile material from the end of the tile engaged with the.

8. A ceiling tile cutter constructed from
a first edge, acting as a straight bar;
the first edge has a recess machined into it so that a standard drop ceiling, ceiling tile can secure in a locked position;
a second edge;
the second edge containing has a slot machined into it where a standard retractable blade knife or any knife using standard knife blades can be inserted for making a cut in a tile;
the second edge attached to the end of the first metal edge containing the machined recess;
the first and second edge pieces are connected to each other such that a slot remains between them where a standard retractable blade knife or any knife using standard knife blades can be inserted for making a cut in a tile;
the first slot and second slot are perpendicular to each other; and
running a knife blade along/through the two perpendicular slots results in a notched removal of the tile material from the end of the tile engaged with the tile cutting device.

9. The device of claim 8 wherein the first and second edges are made from aluminum.

10. The device of claim 8, wherein the first and second edges are made from acrylic plastic that was machined to cut cost until being able to afford injection molding.

11. The device of claim 8, wherein the first and second edges are made from injected molded plastic.
